(19) United States
(12) Patent Application Publication
(10) Pub. No.: US 2015/0287257 A1
(43) Pub. Date: Oct. 8, 2015

(54) ELECTRONIC KEY FOB WITH BLUETOOTH AND RADIO FREQUENCY TRANSCEIVERS

(71) Applicant: VOXX INTERNATIONAL CORPORATION, Hauppauge, NY (US)

(72) Inventor: Michael Stephen Thompson, Douglasville, GA (US)

(73) Assignee: VOXX INTERNATIONAL CORPORATION, Hauppauge, NY (US)

(21) Appl. No.: 14/244,954

(22) Filed: Apr. 4, 2014

(51) Int. Cl. G07C 9/00

(52) U.S. Cl. CPC G07C 9/00896; G07C 9/00309; G07C 2009/00341

(57) ABSTRACT

A key fob including: a long-range transceiver communicating with a vehicle when the fob is within range of a long-range transceiver of the vehicle; and a short-range transceiver communicating with a mobile device when the fob is within range of a short-range transceiver of the mobile device, wherein when the short-range transceiver of the mobile device is out of range of a short-range transceiver of the vehicle, information is transmitted from the mobile device to the vehicle over a short-range link between the mobile device and the fob and is relayed from the fob to the vehicle over a long-range link between the fob and the vehicle, and information is transmitted from the vehicle to the mobile device over the long-range link between the vehicle and the fob and is relayed from the fob to the mobile device over the short-range link between the fob and the mobile device.

### TECHNICAL FIELD

The present invention relates to electronic key fobs.

### DISCUSSION OF THE RELATED ART

An electronic key fob is generally used to lock/unlock/start an automobile. Smart phone applications have been developed to give smart phones the functionality of a key fob. For example, a smart phone with the appropriate software application can be used in place of an electronic key fob to lock and unlock doors, control a car find feature (audible horn honk), start a vehicle remotely, or program auxiliary outputs (like trunk release). However, the wireless communication between the phone and the car generally occurs over a cellular network, thereby introducing latency between command and response time, as well as an increase in cost.

### SUMMARY OF THE INVENTION

According to an exemplary embodiment of the present invention, a key fob for a vehicle comprises: a long-range transceiver configured to communicate with a control device in a vehicle when the key fob is within range of a long-range transceiver of the vehicle; and a short-range transceiver configured to communicate with a mobile device when the key fob is within range of a short-range transceiver of the mobile device, wherein when the short-range transceiver of the mobile device is out of range of a short-range transceiver of the vehicle, information is transmitted from the mobile device to the vehicle over a short-range link between the mobile device and the key fob and is relayed from the key fob to the vehicle over a long-range link between the key fob and the vehicle, and information is transmitted from the vehicle to the mobile device over the long-range link between the vehicle and the key fob and is relayed from the key fob to the mobile device over the short-range link between the key fob and the mobile device.

The long-range transceiver of the key fob includes a radio frequency transceiver.

The short-range transceiver of the key fob includes a bluetooth transceiver.

The information transmitted from the mobile device to the vehicle relates to controlling vehicle functions.

The information transmitted from the vehicle the mobile device includes confirmations or status updates.

According to an exemplary embodiment of the present invention, a fob comprises: a first transceiver configured to communicate with a control device in a vehicle when the fob is within range of a first transceiver of the vehicle; and a second transceiver configured to communicate with a mobile device when the fob is within range of a second transceiver of the mobile device, wherein information is transmitted from the mobile device to the vehicle over a first link between the mobile device and the fob and is relayed from the fob to the vehicle over a second link between the fob and the vehicle.

The first transceiver of the fob includes a radio frequency transceiver.

The second transceiver of the fob includes a bluetooth transceiver.

The information transmitted from the mobile device to the vehicle relates to controlling vehicle functions.

According to an exemplary embodiment of the present invention, a fob comprises: a first transceiver configured to communicate with a control device in a vehicle when the fob is within range of a first transceiver of the vehicle; and a second transceiver configured to communicate with a mobile device when the fob is within range of a second transceiver of the mobile device, wherein information is transmitted from the vehicle to the mobile device over a first link between the vehicle and the fob and is relayed from the fob to the mobile device over a second link between the fob and the mobile device.

The first transceiver of the fob includes a radio frequency transceiver.

The second transceiver of the fob includes a bluetooth transceiver.

The information transmitted from the vehicle the mobile device includes confirmations or status updates.

### BRIEF DESCRIPTION OF THE DRAWINGS

FIG. 1 is a block diagram of a system according to an exemplary embodiment of the present invention;

FIG. 2 is a coverage diagram of a system according to an exemplary embodiment of the present invention;

FIG. 3 is a flowchart of a method according to an exemplary embodiment of the present invention; and

FIG. 4 illustrates a computer system in which an exemplary embodiment of the present invention may be implemented.

### DETAILED DESCRIPTION OF EXEMPLARY EMBODIMENTS

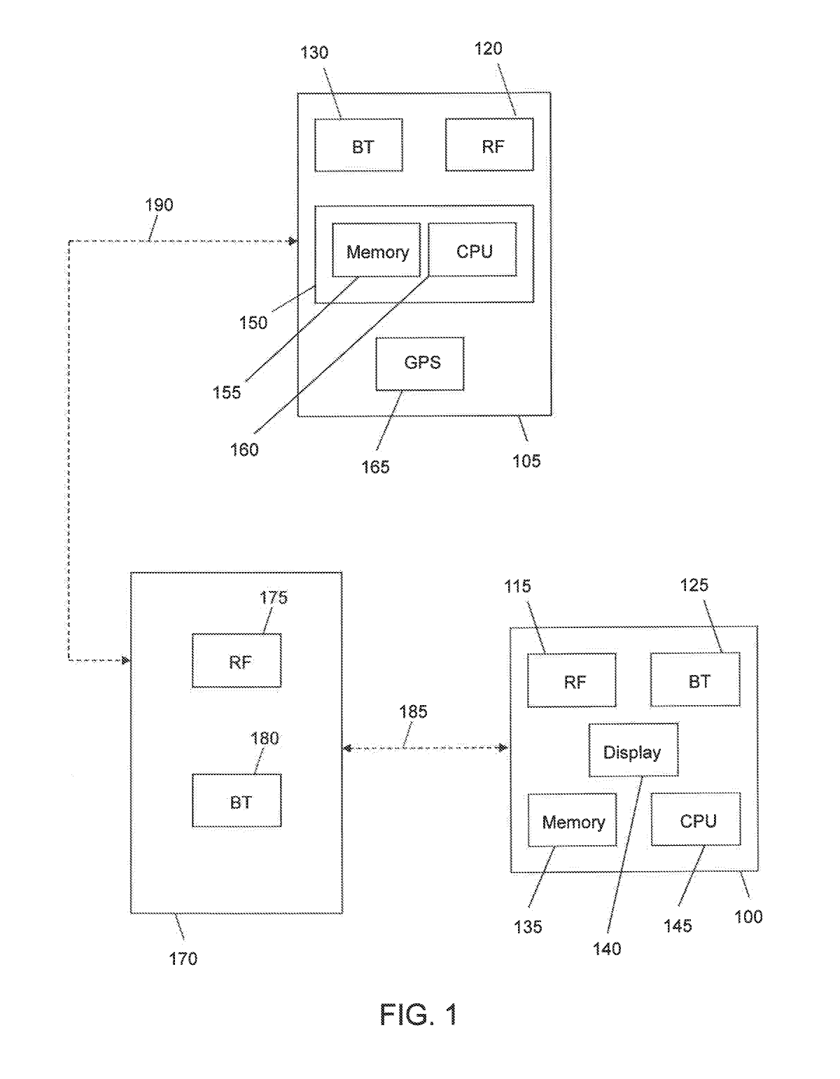

FIG. 1 is a block diagram of a system according to an exemplary embodiment of the present invention.

As shown in FIG. 1, the system may include a mobile device 100, a vehicle 105 and a key fob 170. The mobile device 100 may be a smart phone, for example. The vehicle 105 may be a passenger car, for example. The mobile device 100 may be used to make phone calls via a cellular network. The mobile device 100 may access the internet via the network. The vehicle 105 may also be communicably coupled to the cellular network.

The mobile device 100 may include, but is not limited to, a long-range radio frequency (RF) transceiver 115, a short-range bluetooth transceiver 125 (or a bluetooth 4.0 transmitter, for example), a memory 135, a central processing unit (CPU) 145 and a display 140.

In the case that the mobile device 100 is a smart phone, the smart phone is a mobile phone built on a mobile operating system. The display 140 may be a touchscreen and have a web browser that displays standard web pages as well as mobile-optimized sites. High-speed data access may be provided by Wi-Fi and mobile broadband. The smart phone can make and receive telephone calls by connecting to the cellular network with the RF transceiver 115. Web pages may be displayed on the display 140 under control of the CPU 145 and memory 135.

Other than a smart phone, the mobile device 100 may be a handheld computing device having a display screen with touch input and/or a miniature keyboard. The mobile device 100 may also be a laptop computer or a bluetooth badge.

The vehicle 105 may include an RF transceiver 120 for communicating with the network and a bluetooth transceiver 130 for communicating with the mobile device 100 via the bluetooth transceiver 125 of the mobile device 100. The bluetooth transceiver 130 may be a bluetooth 4.0 receiver (with or without transmit ability) that can plug into a telematics/DBI port in the vehicle 105. In the alternative, the vehicle 105 may not include the bluetooth transceiver 130. The vehicle 105 may include a global positioning system (GPS) module 165 that can be used to provide location information of the vehicle 105. The vehicle 105 may further include a control unit 150, itself including a memory 155 and CPU 160. The control unit 150 may be an embedded system that controls one or more of the electrical system or subsystems in the vehicle 105. The control unit 150 may be a vehicle security pre-load module. As an example, the control unit 150 may be part of a remote keyless entry system, passive entry or push-button start system. The bluetooth 4.0 receiver, or alternatively a near field communication (NFC) receiver, may be embedded in the control unit 150.

A remote keyless entry system may refer to a lock that uses an electronic remote control as a key which is activated by a handheld device or automatically by proximity. A passive entry system or push button start system may include a key that allows a driver to keep the key in their pocket when unlocking, locking and starting a vehicle. The key fob 170 of the present invention may be used with either of these systems.

The key fob 170 may include a long-range RF transceiver 175 and a short-range bluetooth transceiver 180. Although not shown, the key fob 170 may further include a CPU, a memory, a battery and buttons. The buttons on the key fob 170 may be used for direct control of the control device 150 in the vehicle 105. The key fob 170 includes, but is not limited to, a key chain fob carried by a user.

The RF transceiver 175 is used for sending commands to the control device 150 in the vehicle 105 for controlling vehicle functions including but not limited to locking the doors, unlocking the doors, opening the trunk, or remote starting the engine. The RF transceiver 175 may also receive commands and/or status updates from the control device 150 in the vehicle 105 that are communicated to the user. As shown in FIG. 1, the key fob 170 and the vehicle 105 communicate via wireless link 190.

The bluetooth transceiver 180 allows the key fob 170 to communicate with the mobile device 100 via wireless link 185. For example, the key fob 170 will receive commands from the mobile device 100 via the bluetooth link 185 and relay them to the vehicle 105 via the RF link 190. The key fob 170 may also receive confirmations and/or status updates from the vehicle 105 via the RF link 190 and relay them to the user via the bluetooth link 185. The commands may be entered through an interface on the display 140 of the mobile device 100. The confirmations and/or status updates may be shown on the display 140.

When the mobile device 100 has an application installed that permits it to be used in place of an electronic key fob to lock and unlock doors, control a car find feature (audible horn honk), start a vehicle remotely, or programauxiliary outputs (like trunk release), the display 140 may show a variety of icons related to key fob functionality. For example, an individual icon may be shown for each of lock, unlock, find and start functions and may be responsive to user touch. The application may further enable a user to get vehicle diagnostic information or set preferences by way of the display 140.

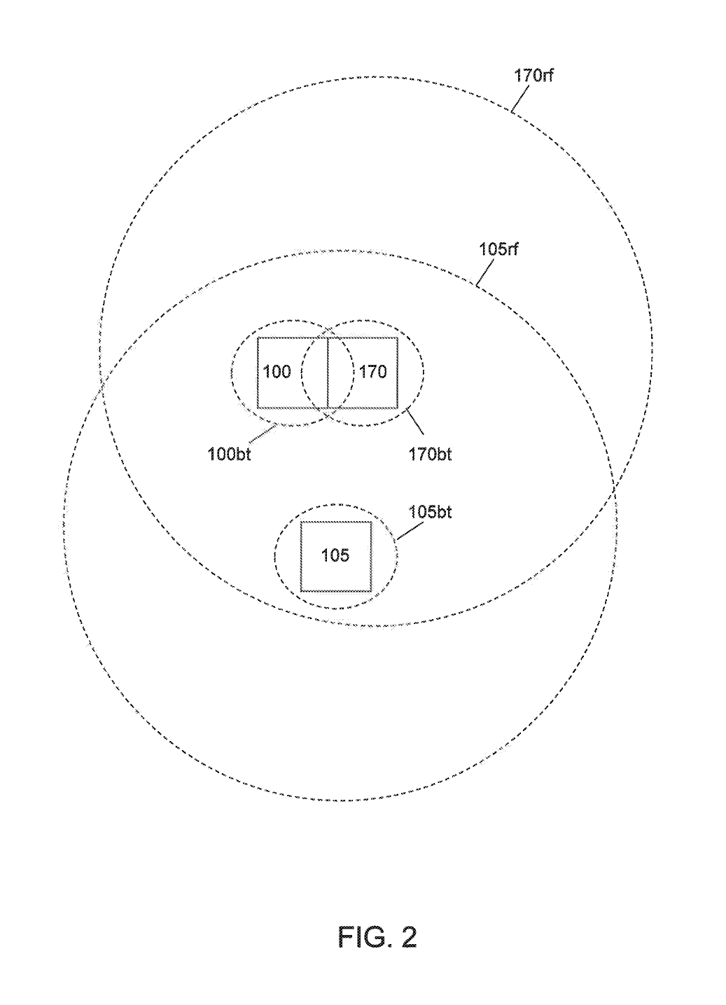

FIG. 2 is a coverage diagram of a system according to an exemplary embodiment of the present invention.

As shown in FIG. 2, the bluetooth transceiver 130 of the vehicle 105 has coverage area 105bt (e.g., 50-60 feet), and the RF transceiver 120 of the vehicle 105 has coverage area 105rf (e.g., 5,000+ feet). The bluetooth transceiver 125 of the mobile device 100 has coverage area 100bt (e.g., 50-60 feet). The bluetooth transceiver 180 of the key fob 170 has coverage area 170bt (e.g., 50-60 feet), and the RF transceiver 175 of the key fob 170 has coverage area 170rf (e.g., 5,000+ feet).

In the example shown in FIG. 2, the mobile device 100 and the key fob 170 are shown together since they are typically held by the same person. As can be seen, when the mobile device 100 is out of bluetooth range with respect to the vehicle 105, communication can be done via RF over a cellular network. Such communication may have a time delay and result in increased cost. This is so, because a cellular plan is generally required to utilize this form of communication. In accordance with an exemplary embodiment of the present invention, instead of having to communicate with the vehicle 105 via the cellular network when out of bluetooth range, the mobile device 100 may instead communicate with the vehicle 105 through the key fob 170.

For example, information to be communicated to the vehicle 105 from the mobile device 100 may be transmitted via the bluetook link 185 with the key fob 170, since their bluetooth ranges 100bt and 170bt overlap. The key fob 170 may then relay this information to the vehicle 105 over the RF link 190, since their RF ranges 105rf and 170rf overlap. Further, information to be communicated to the mobile device 100 from the vehicle 105 may be transmitted via the RF link 190 to the key fob 170, since their RF ranges 105rf and 170rf overlap. The key fob 170 may then relay this information to the mobile device 100 over the bluetooth link 185, since their bluetooth ranges 100bt and 170bt overlap. This results in quicker response times, reduced cost, and enhanced user experience due to the utilization of the mobile device's 100 (e.g., smart phone) existing interface features without having to replicate them within the key fob 170. This also results in a reduced size of the key fob 170 for improved ergonomics.

It is to be understood that the information transmitted from the vehicle 105 via the key fob 170 to the mobile device 100 does not have to be requested from the mobile device 100. This information may be set to be periodically transmitted to the mobile device 100 and may include, inter alia, alarm alerts, system statuses of the vehicle 105, or alerts regarding any changes within the vehicle 105.

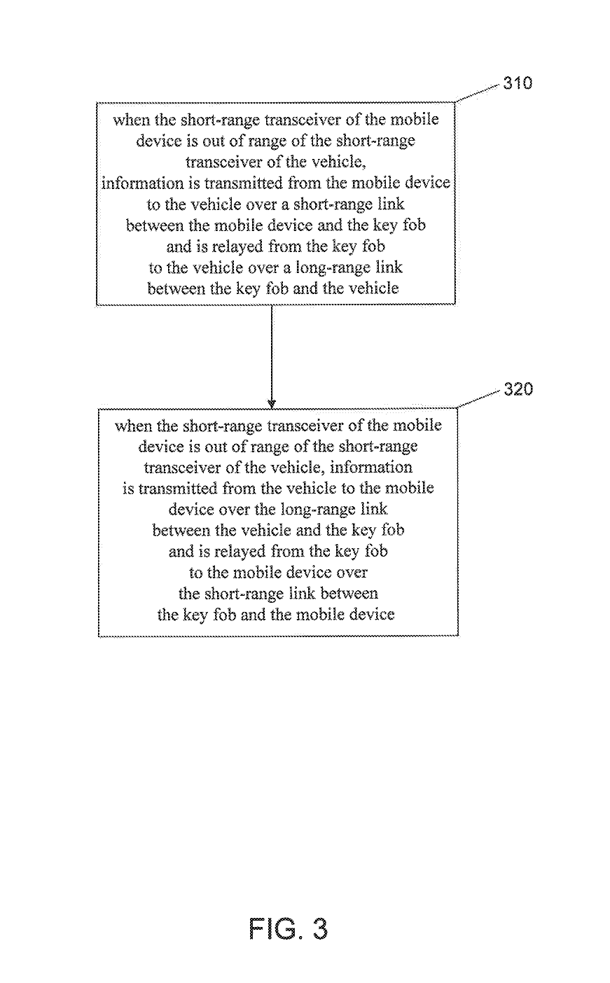

FIG. 3 is a flowchart of a method according to an exemplary embodiment of the present invention.

As shown in FIG. 3, with reference to FIGS. 1 and 2, when the short-range transceiver 125 of the mobile device 100 is out of range of the short-range transceiver of the vehicle 105, information is transmitted from the mobile device 100 to the vehicle 105 over a short-range link 185 between the mobile device 100 and the key fob 170 and is relayed from the key fob 170 to the vehicle 105 over a long-range link 190 between the key fob 170 and the vehicle 105 (310), and information is transmitted from the vehicle 105 to the mobile device 100 over the long-range link 190 between the vehicle 105 and the key fob 170 and is relayed from the key fob 170 to the mobile device 100 over the short-range link 185 between the key fob 170 and the mobile device 100 (320).

It is to be understood that although the aforementioned description of FIGS. 2 and 3 is premised on the fact that when the mobile device 100 is out of bluetooth range of the vehicle 105, communication between the mobile device 100 and the vehicle 105 is enabled by the key fob 170, the present invention is not limited thereto. For example, key fob 170 may enable communication between the mobile device 100 and the vehicle 105 in any circumstance as long as the key fob 170 can establish a wireless connection with the vehicle 105.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention e described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article or manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

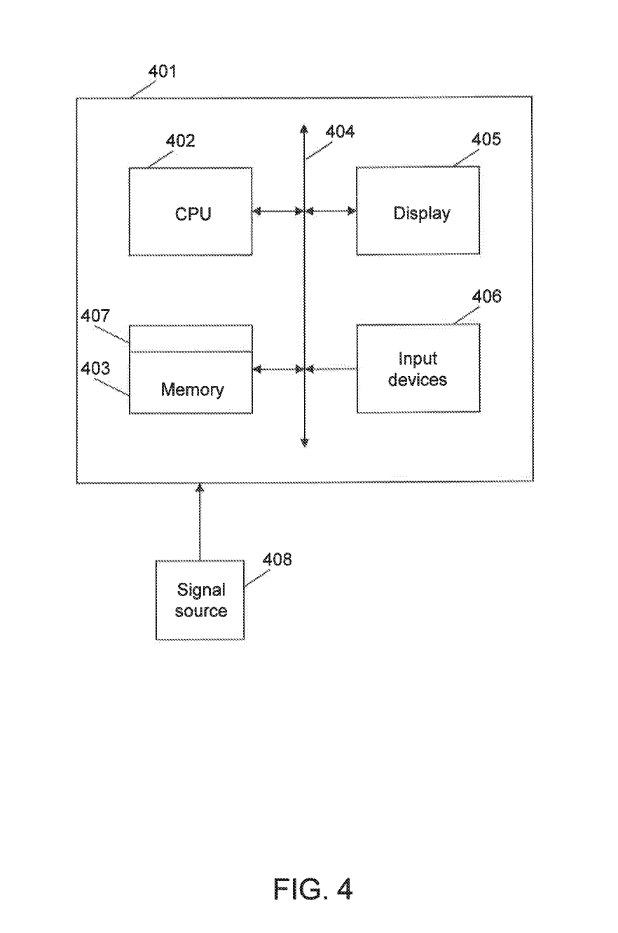

Referring now to FIG. 4, according to an exemplary embodiment of the present invention, a computer system 401 can comprise, inter alia, a central processing unit (CPU) 402, a memory 403 and an input/output (110) interface 404. The computer system 401 is generally coupled through the I/O interface 404 to a display 405 and various input devices 406 such as a mouse and keyboard. The support circuits can include circuits such as cache, power supplies, clock circuits, and a communications bus. The memory 403 can include RAM, ROM, disk drive, tape drive, etc., or a combination thereof. Exemplary embodiments of present invention may be implemented as a routine 407 stored in memory 403 (e.g., a non-transitory computer-readable storage medium) and executed by the CPU 402 to process the signal from a signal source 408. As such, the computer system 401 is a general-purpose computer system that becomes a specific purpose computer system when executing the routine 407 of the present invention.

The computer system 401 also includes an operating system and micro-instruction code, The various processes and functions described herein may either be part of the micro-instruction code or part of the application program (or a combination thereof) which is executed via the operating system. In addition, various other peripheral devices may be connected to the computer system 401 such as an additional data storage device and a printing device. Aspects of the computer system 401 are applicable to the mobile device 100, vehicle 105 and key fob 170 of FIG. 1.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described to best explain the principles of the invention and the practical application, and to enable others of ordinary skill in the art to understand the invention for various embodiments with various modifications as are suited to the particular use contemplated.

What is claimed is:

1. A key fob for a vehicle, comprising:
a long-range transceiver configured to communicate with a control device in a vehicle when the key fob is within range of a long-range transceiver of the vehicle; and
a short-range transceiver configured to communicate with a mobile device when the key fob is within range of a short-range transceiver of the mobile device,
wherein when the short-range transceiver of the mobile device is out of range of a short-range transceiver of the vehicle,
information is transmitted from the mobile device to the vehicle over a short-range link between the mobile device and the key fob and is relayed from the key fob to the vehicle over a long-range link between the key fob and the vehicle, and
information is transmitted from the vehicle to the mobile device over the long-range link between the vehicle and the key fob and is relayed from the key fob to the mobile device over the short-range link between the key fob and the mobile device.

2. The key fob of claim 1, wherein the long-range transceiver of the key fob includes a radio frequency transceiver.

3. The key fob of claim 1, wherein the short-range transceiver of the key fob includes a bluetooth transceiver.

4. The key fob of claim 1, wherein the information transmitted from the mobile device to the vehicle relates to controlling vehicle functions.

5. The key fob of claim 1, wherein the information transmitted from the vehicle the mobile, device includes confirmations or status updates.

6. A fob, comprising:
a first transceiver configured to communicate with a control device in a vehicle when the fob is within range of a first transceiver of the vehicle; and
a second transceiver configured to communicate with a mobile device when the fob is within range of a second transceiver of the mobile device,
wherein information is transmitted from the mobile device to the vehicle over a first link between the mobile device and the fob and is relayed from the fob to the vehicle over a second link between the fob and the vehicle.

7. The fob of claim 6, wherein the first transceiver of the fob includes a radio frequency transceiver.

8. The fob of claim 6, wherein the second transceiver of the fob includes a bluetooth transceiver.

9. The fob of claim 6, wherein the information transmitted from the mobile device to the vehicle relates to controlling vehicle functions.

10. A fob, comprising:
a first transceiver configured to communicate with a control device in a vehicle when the fob is within range of a first transceiver of the vehicle; and
a second transceiver configured to communicate with a mobile device when the fob is within range of a second transceiver of the mobile device,
wherein information is transmitted from the vehicle to the mobile device over a first link between the vehicle and the fob and is relayed from the fob to the mobile device over a second link between the fob and the mobile device.

11. The fob of claim 10, wherein the first transceiver of the fob includes a radio frequency transceiver.

12. The fob of claim 10, wherein the second transceiver of the fob includes a bluetooth transceiver.

13. The fob of claim 10, wherein the information transmitted from the vehicle the mobile device includes confirmations or status updates.
